(19) United States
(12) Patent Application Publication
(10) Pub. No.: US 2025/0108292 A1
(43) Pub. Date: Apr. 3, 2025

(54) OVER-FITTING A TRAINING SET FOR A MACHINE LEARNING (ML) MODEL FOR A SPECIFIC GAME AND GAME SCENE FOR ENCODING

(71) Applicant: Sony Interactive Entertainment Inc., Tokyo (JP)

(72) Inventors: Deepali Arya, San Mateo, CA (US); Eric Hsuming Chen, San Mateo, CA (US); Jason Wang, San Mateo, CA (US); Hung-Ju Lee, San Mateo, CA (US)

(21) Appl. No.: 18/478,057

(22) Filed: Sep. 29, 2023

(51) Int. Cl. A63F 13/355; H04N 19/513

(52) U.S. Cl. CPC A63F 13/355; H04N 19/513; A63F 2300/572

(57) ABSTRACT

Techniques are described for over-training a ML model on multiple gameplay videos of individual scenes of a computer game to better configure the model to reconstruct or enhance portions of the computer game at a receiver as the computer game is received over a streamlining network. Reconstruction of individual missing slices of a frame is contemplated such that a frame missing a slice need not be entirely discarded.

### FIELD

The present application relates to technically inventive, non-routine solutions that are necessarily rooted in computer technology and that produce concrete technical improvements, and more specifically to over-fitting a training set for a machine learning (ML) model for a specific game and game scene for encoding.

### BACKGROUND

In video streaming over a network such as computer game streaming, frames and/or portions of a frame such as slices may be lost entirely or may arrive with low quality.

### SUMMARY

As understood herein, not only does the above problem deleteriously affect presentation of the frame itself, but also potentially the presentation of other frames that may reference the missing portions.

Accordingly, an apparatus includes at least one processor assembly configured to over-fit at least one machine learning (ML) model by training the ML model on plural ground truth gameplay video recordings of a computer game to produce a trained ML model. The processor assembly is configured to use the trained ML model to reconstruct at least a portion of at least one frame of video from the computer game during streaming of the computer game to a receiver over a network.

In some embodiments the processor assembly can be configured to train the ML model on plural gameplay video recordings of plural individual scenes in the computer game, and signal a scene indication to the trained ML model along with the frame of video to be reconstructed.

In example embodiments, the portion of the frame can be an individual slice of the frame. The frame can be a first frame and the processor assembly can be configured to use the trained ML model to reconstruct missing compressed domain information of the first slice and only the first slice for use in presenting a second frame referencing the first frame. For example, the compressed domain information may include motion vectors.

In other implementations the processor assembly can be configured to use a slice and only a slice from a frame prior to the first frame to reconstruct missing compressed domain information of the first slice for use in presenting a second frame referencing the first frame.

In non-limiting examples, the portion of the frame of video can be received with a first quality, and the processor assembly can be configured to use the trained ML model to reconstruct the portion of the frame of video by enhancing the first quality to be a second quality.

In another aspect, an apparatus includes at least one computer medium that is not a transitory signal and that in turn includes instructions executable by at least one processor assembly to identify a missing or low quality slice of a frame of video, and use a machine learning (ML) model to enhance at least the slice.

In another aspect, a method includes identifying at least a portion of a frame of video received over a computer network is missing or is low quality, and reconstructing or enhancing at least the portion using a machine learning (ML) model over-trained on the video.

The details of the present disclosure, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system including an example in consistent with present principles;

FIG. 2 illustrates an example encoder-decoder system;

FIG. 3 illustrates example overfitting logic in example flow chart format;

FIG. 4 illustrates example transmission logic in example flow chart format;

FIG. 5 illustrates example receiver logic in example flow chart format;

FIG. 6 illustrates an example streaming service with three example computer games;

FIG. 7 illustrates an example overfitting training set consistent with FIG. 6;

FIG. 8 illustrates a missing frame slice in a streaming system;

FIG. 9 illustrates example logic in example flow chart format to enhance a low quality slice at the decoder;

FIG. 10 illustrates example training logic for the machine learning (ML) model used in FIG. 9;

FIG. 11 illustrates example logic in example flow chart format to process slices while reconstructing missing compression data; and

FIGS. 12-14 illustrate example logic in example flow chart format for training respective ML models use in the example of FIG. 12.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, extended reality (XR) headsets such as virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony PlayStation®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers. A processor including a digital signal processor (DSP) may be an embodiment of circuitry. A processor assembly may include one or more processors.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

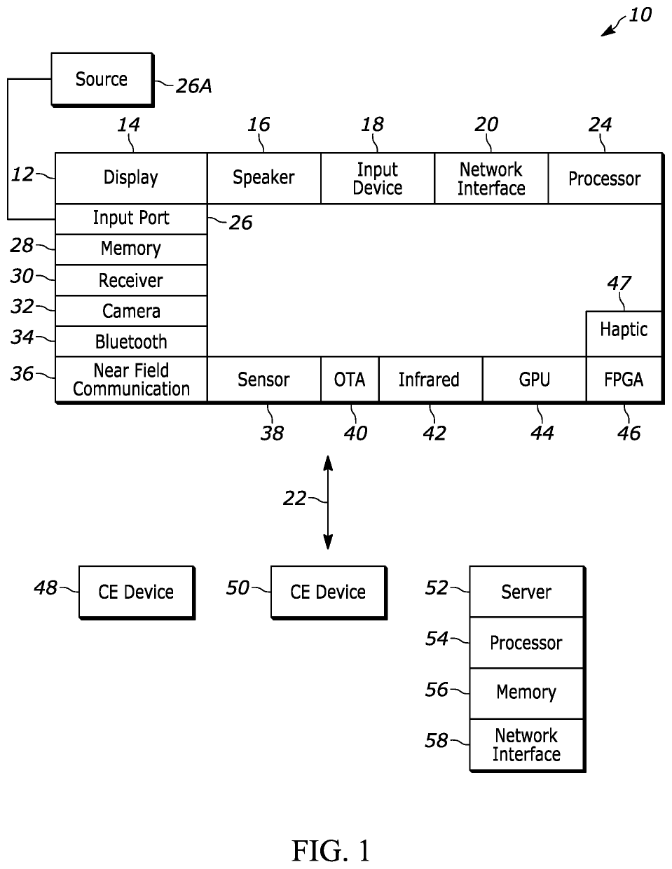

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage media 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24.

Continuing the description of the AVD 12, in some embodiments the AVD 12 may include one or more cameras 32 that may be a thermal imaging camera, a digital camera such as a webcam, an IR sensor, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc. Other sensor examples include a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command). The sensor 38 thus may be implemented by one or more motion sensors, such as individual accelerometers, gyroscopes, and magnetometers and/or an inertial measurement unit (IMU) that typically includes a combination of accelerometers, gyroscopes, and magnetometers to determine the location and orientation of the AVD 12 in three dimension or by an event-based sensors such as event detection sensors (EDS). An EDS consistent with the present disclosure provides an output that indicates a change in light intensity sensed by at least one pixel of a light sensing array. For example, if the light sensed by a pixel is decreasing, the output of the EDS may be −1; if it is increasing, the output of the EDS may be a +1. No change in light intensity below a certain threshold may be indicated by an output binary signal of 0.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

A light source such as a projector such as an infrared (IR) projector also may be included.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content (more generally, extended reality (XR) content). The HMD may be configured as a glasses-type display or as a bulkier VR-type display vended by computer game equipment manufacturers.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles may employ various machine learning models, including deep learning models. Machine learning models consistent with present principles may use various algorithms trained in ways that include supervised learning, unsupervised learning, semi-supervised learning, reinforcement learning, feature learning, self-learning, and other forms of learning. Examples of such algorithms, which can be implemented by computer circuitry, include one or more neural networks, such as a convolutional neural network (CNN), a recurrent neural network (RNN), and a type of RNN known as a long short-term memory (LSTM) network. Generative pre-trained transformers (GPTT) also may be used. Support vector machines (SVM) and Bayesian networks also may be considered to be examples of machine learning models. In addition to the types of networks set forth above, models herein may be implemented by classifiers.

As understood herein, performing machine learning may therefore involve accessing and then training a model on training data to enable the model to process further data to make inferences. An artificial neural network/artificial intelligence model trained through machine learning may thus include an input layer, an output layer, and multiple hidden layers in between that that are configured and weighted to make inferences about an appropriate output.

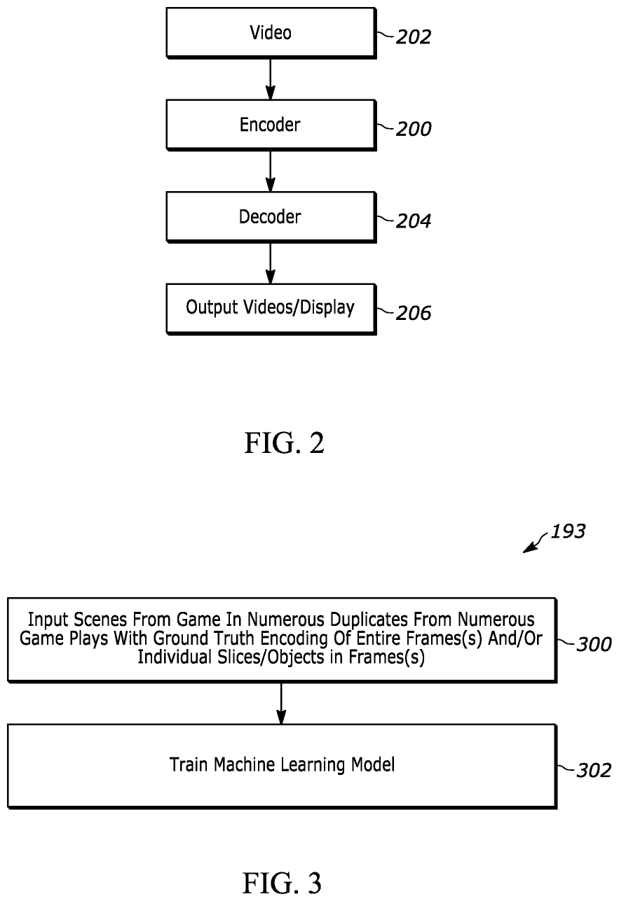

FIG. 2 illustrates a system that includes a video encoder 200 for encoding/compressing videos 202. A video decoder 204 can receive the encoded videos and decode/decompress them into output videos 206.

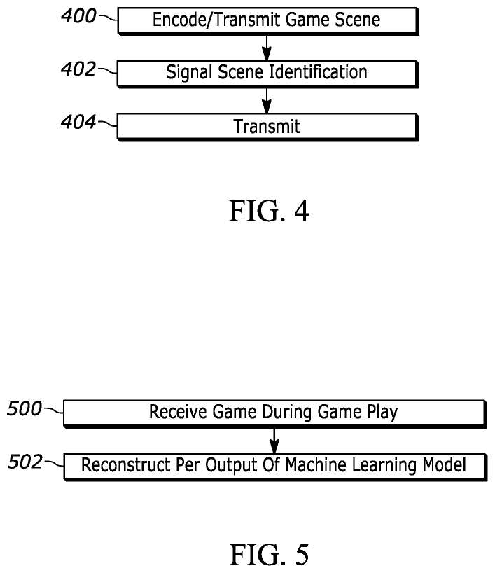

FIG. 3 illustrates over-fitting the training set for a ML model for a specific game and even specific scene in the game so the level of coding can be carefully tailored, time slice to time slice. State 300 indicates that a training set of data is input to ML model to train the model at state 302. The training set may be limited to multiple ground truth game play videos of the same computer game or small set computer games as may be hosted on a streaming service. If desired, for games with plural scenes, for each scene, multiple game plays of that scene along with scene and game identification may be used in the training set, so that the ML model can be trained not only on multiple game play videos from a closed or limited set of computer games, but also, in some embodiments, on a scene-by-scene basis for the closed set of computer games.

This is a general case. As described further below, one or more ML models may be trained on a closed set of computer games not only on a scene-by-scene basis but also on a frame slice-by-frame-slice basis consistent with the overfitting principles of FIG. 3.

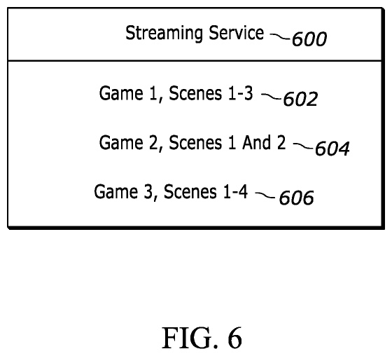

FIG. 4 illustrates that once trained, the ML model can be used as follows. At state 400 a game scene is encoded and transmitted along with, at state 402, an identification of the game and scene. This information is transmitted at state 404.

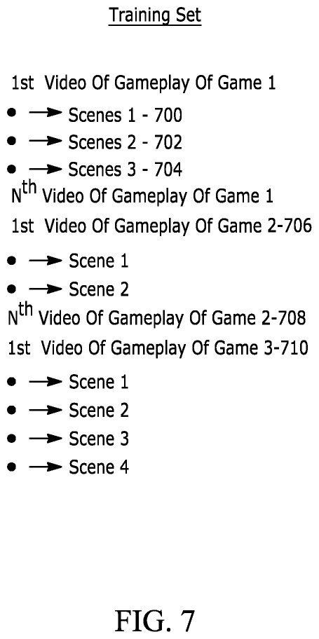

The receiving decoder system may receive the game information at state 500 of FIG. 5 that was transmitted in FIG. 4 and employ the ML model at state 502 trained according to FIG. 3 to reconstruct any poor quality or missing portions of the computer game according to its training.

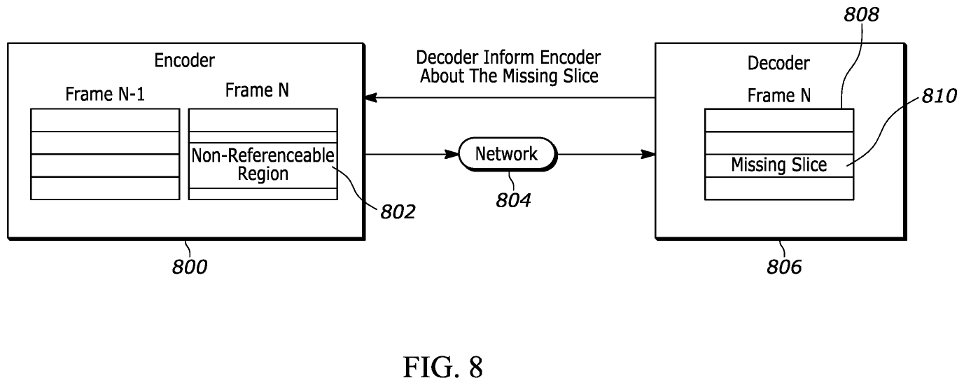

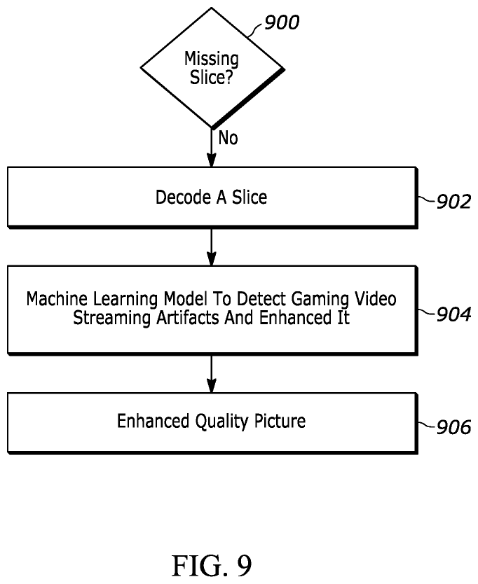

FIGS. 6 and 7 illustrate the technique of FIG. 3 further. Assume for example purposes that a streaming service 600 can source a closed set of computer games, such as a first game 602 with three scenes, a second game 604 with two scenes, and a third game 606 with four scenes.

The training set for FIG. 3 derived from the non-limiting illustrative example FIG. 6 is illustrated in FIG. 7. A first game play video of the first game 602 with its three scenes 700, 702, 704 is part of the training set, as are plural additional game play videos of the first game 602 on a scene-by-scene basis up to an N^{th} game play video of the first game 602.

Similarly, a first game play video of the second game 604 in FIG. 6, labeled 706 in FIG. 7, is part of the training set on a scene-by-scene basis if desired for each of its two scenes, and as indicated at 708, multiple game play videos of the second game may be part of the training set.

Likewise, a first game play video of the third game 606 in FIG. 6, labeled 710 in FIG. 7, is part of the training set on a scene-by-scene basis if desired for each of its four scenes, and multiple game play videos of the third game may be part of the training set.

As alluded to above, whether using an overfit training set or other techniques, present principles envision training one or more ML models to reconstruct missing portions of frames, referred to herein as slices. Typically when a slice is missing during transmission, because the decoder may depend on the missing slice not only for pixel data for the relevant frame but also for reference information for future frame reconstruction, the entire frame is discarded, and either a new reference frame must be sent, which consumes bandwidth and increases latency, or reference must be made to other, e.g., earlier, reference frames, which can result in loss of accuracy and picture degradation. Accordingly, techniques are described herein for calculating missing slices and in some embodiments their relevant compressed domain information (such as motion vectors). In an example, macroblocks (or coding tree units (CTU), depending on codec type) of a missing slice are forced to be encoded as Intraframe MBs or CTUs. Another technique is to make reference to a prior frame when coding the missing slice of the current frame.

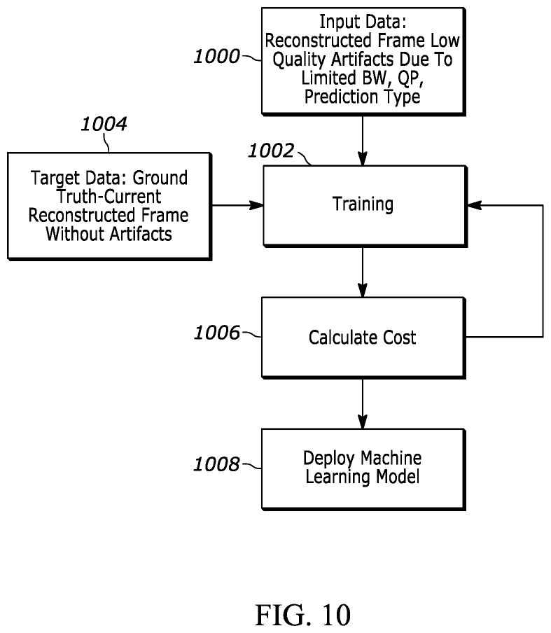

This is illustrated in FIG. 8. An encoder 800 sends, in succession, frame N−1 and then frame N, which has a non-referenceable region or slice 802. The frames are sent over a computer network 804 to a receiver 806 the decoder of which receives the frames (only frame N shown in the decoder side) with the resulting missing slice 810. The rest of frame N, however, remains decodable.

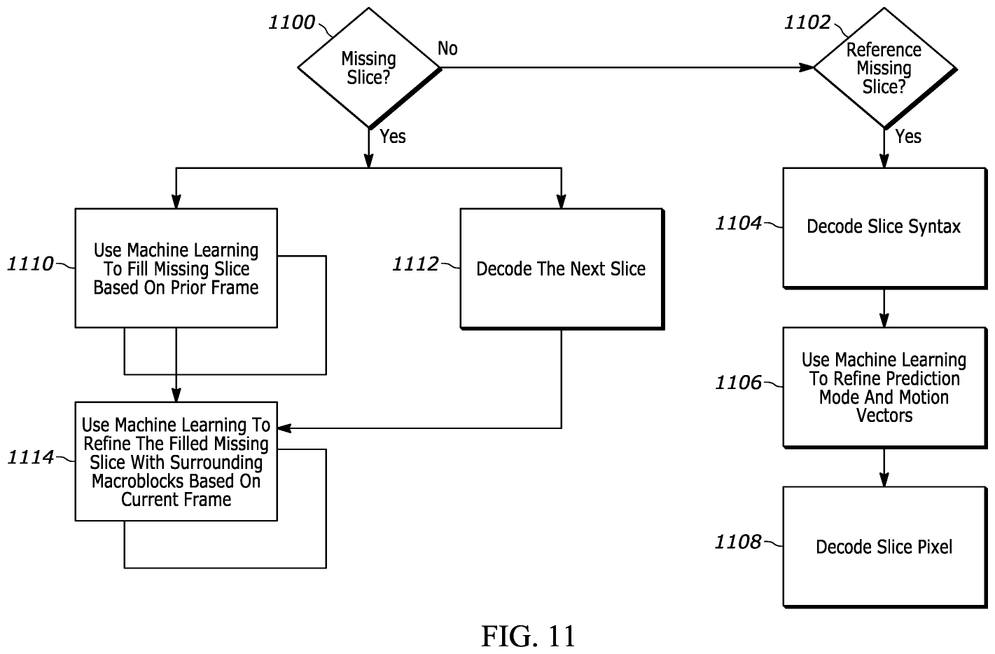

State 900 in FIG. 9 illustrates that when a slice of a frame is determined not to be missing, the slice is decoded at state 902. Moving to state 904, a ML model processes the slice to remove/correct any artifacts in the slice and enhance its quality. Each slice of a frame is thus decoded and enhanced by the ML model on a slice-by-slice basis to enhance picture quality at state 906.

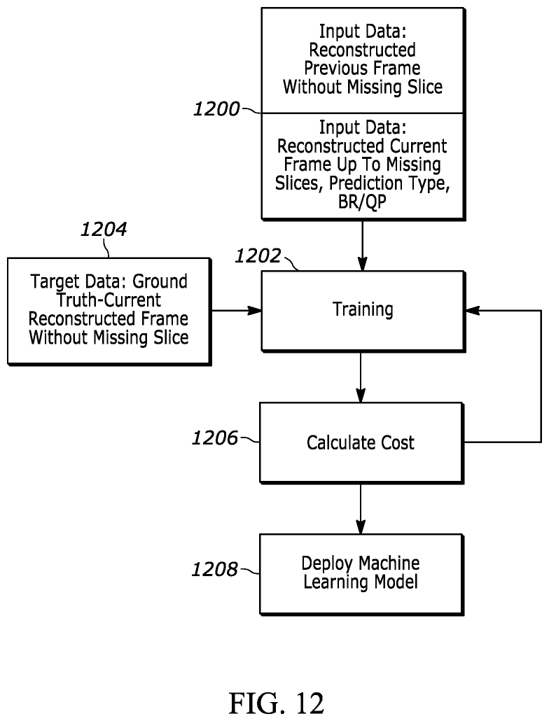

FIG. 10 illustrates how the ML model used in FIG. 9 may be trained. Input data is input to the model at state 1000 to train the model at state 1002. The input data may include reconstructed frame low quality artifacts from game play videos caused by limited bandwidth, for example. The reconstructed frame low quality artifacts may be accompanied by quantization parameter (QP) and prediction type.

Additionally, target data 1004 may be input to the training block. The target data may include ground truth of the frames input at state 1000 without any artifacts.

State 1006 is a post-training cost calculation step consistent with ML principles in which a cost function is applied to determine how well the ML model is predicting corrective action based on additional example input frames with artifacts. Once the cost function indicates an acceptable cost, the model may be deployed for use at state 1008.

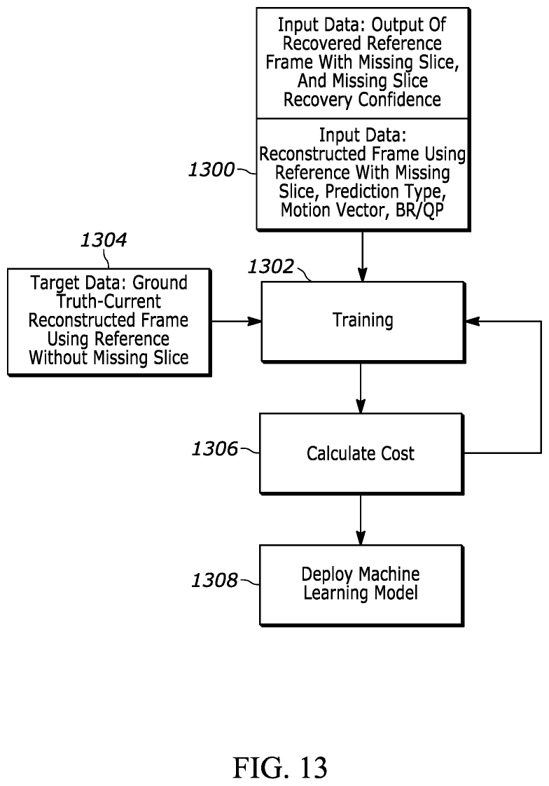

As mentioned above, when a slice of a frame is missing, not only is the picture pixel data of that slice lost, but also potential loss of compressed domain information such as motion vectors or the like that are used as a reference for reconstructing other frames arises. Refer now to FIG. 11 for solutions to this potential problem.

State 1100 indicates that if a slice is not missing, the logic of the decoder may move to state 1102 to determine whether the slice references another slice, potentially from another frame, that is missing. If this is the case, the syntax of the slice examined at state 1100 is decoded at state 1104, and one or more ML models (such as may be trained using the technique of FIG. 13) are used at state 1106 to refine prediction mode of the slice and relevant motion vectors that otherwise would have been supplied by the missing slice. The slice pixels are decoded at state 1108 for presentation.

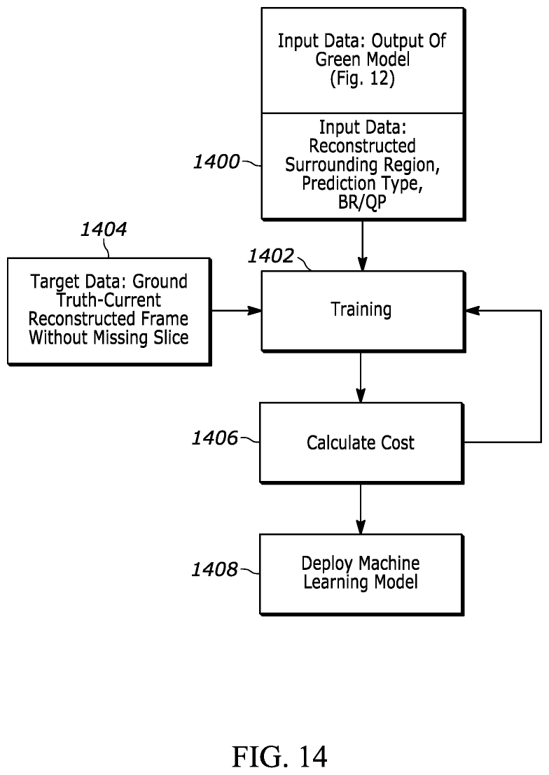

On the other hand, if, during decoding a frame of video such as game play video, a missing slice is detected at state 1100, the logic may move in parallel to states 1110 and 1112. State 1110 indicates that one or more ML models (such as may be trained according to FIG. 12) are employed to fill in the pixels of the missing slice based on at least one previous frame. State 1112 indicates that in parallel with state 1110, the next slice of the frame is decoded, and the logic moves to state 1114. At state 1114 one or more ML models such as may be trained according to FIG. 14 are used to refine the now-filled in previously missing slice with surrounding macroblocks (or equivalently CTUs) based on the current frame including the next slice decoded at state 1112.

FIG. 12 illustrates how the ML model used at state 1110 in FIG. 11 may be trained. Training data is input to the model at state 1200 to train the model at state 1202. The input data may include a reconstructed previous frame to the current frame without any missing slices and a reconstructed current frame up to the point of a missing slice or slices, along with prediction type and bitrate (BR)/quantization parameter (QP).

Additionally, target data 1204 may be input to the training block. The target data may include ground truth reconstructed version of the current frame without the missing slice. State 1206 is a post-training cost calculation step consistent with ML principles in which a cost function is applied to determine how well the ML model is predicting corrective action based on additional example input frames with missing slices. Once the cost function indicates an acceptable cost, the model may be deployed for use at state 1208.

FIG. 13 illustrates how the ML model used at state 1106 in FIG. 11 may be trained. Training data is input to the model at state 1300 to train the model at state 1302. The input data may include the output of a recovered reference frame with the missing slice and a confidence measure of the missing slice recovery efficacy. The training data may also include a frame reconstructed using reference data (compressed domain information) with missing slice along with the compressed domain information such as motion vectors, prediction type, and bitrate (BR)/quantization parameter (QP).

Additionally, target data 1304 may be input to the training block. The target data may include ground truth reconstructed version of the current frame without the missing slice.

State 1306 is a post-training cost calculation step consistent with ML principles in which a cost function is applied to determine how well the ML model is predicting corrective action based on additional example input frames with missing slices. Once the cost function indicates an acceptable cost, the model may be deployed for use at state 1308.

FIG. 14 illustrates how the ML model used at state 1114 in FIG. 11 may be trained. Training data is input to the model at state 1400 to train the model at state 1402. The input data may include the output of the model trained according to FIG. 12 along with reconstructed surrounding portions of the missing slice. The training data may also include prediction type, and bitrate (BR)/quantization parameter (QP).

Additionally, target data 1404 may be input to the training block. The target data may include ground truth reconstructed version of the current frame without the missing slice.

State 1406 is a post-training cost calculation step consistent with ML principles in which a cost function is applied to determine how well the ML model is predicting corrective action based on additional example input frames with missing slices. Once the cost function indicates an acceptable cost, the model may be deployed for use at state 1408.

In some examples, periodically the encoder may up-resolution an I-frame using super resolution to use as reference. If the super resolution is done by the decoder, motion vectors may require modification. In any case, super resolution of an I-frame can produce an anchor frame P-frames.

While particular techniques are herein shown and described in detail, it is to be understood that the subject matter which is encompassed by the present application is limited only by the claims.

1. An apparatus comprising:
at least one processor assembly configured to:
over-fit at least one machine learning (ML) model by training the ML model on plural ground truth gameplay video recordings of a computer game to produce a trained ML model; and
use the trained ML model to reconstruct at least a portion of at least one frame of video from the computer game during streaming of the computer game to a receiver over a network, wherein the portion comprises an individual slice of the frame, wherein the slice is a first slice and the frame is a first frame, and the processor assembly is configured to use the trained ML model to reconstruct missing compressed domain information of the first slice and only the first slice for use in presenting a second frame referencing the first frame.

2. The apparatus of claim 1, wherein the processor assembly is configured to:
train the ML model on plural gameplay video recordings of plural individual scenes in the computer game; and
signal a scene indication to the trained ML model along with the frame of video to be reconstructed.

3-4. (canceled)

5. The apparatus of claim 1, wherein the compressed domain information comprises motion vectors.

6. An apparatus comprising:
at least one processor assembly configured to:
over-fit at least one machine learning (ML) model by training the ML model on plural ground truth gameplay video recordings of a computer game to produce a trained ML model;
use the trained ML model to reconstruct at least a first slice of at least a first frame of video from the computer game during streaming of the computer game to a receiver over a network; and
use a slice and only a slice from a frame prior to the first frame to reconstruct missing compressed domain information of the first slice for use in presenting a second frame referencing the first frame.

7. The apparatus of claim 1, wherein the portion of the frame of video is received with a first quality, and the processor assembly is configured to:
use the trained ML model to reconstruct the portion of the frame of video by enhancing the first quality to be a second quality.

8. An apparatus comprising:
at least one computer medium that is not a transitory signal and that comprises instructions executable by at least one processor assembly to:
identify a missing or low quality slice of a frame of video; and
use a machine learning (ML) model to enhance at least the slice, wherein the frame is a first frame and the instructions are executable to:
use the ML model to reconstruct missing compressed domain information of the slice for use in presenting a second frame referencing the first frame.

9. The apparatus of claim 8, wherein the instructions are executable to:
use the ML model to enhance at least the slice by reconstructing the slice.

10. The apparatus of claim 8, wherein the instructions are executable to:
use the ML model to enhance at least the slice by enhancing quality of the slice.

11. (canceled)

12. The apparatus of claim 8, wherein the compressed domain information comprises motion vectors.

13. An apparatus comprising:
at least one computer medium that is not a transitory signal and that comprises instructions executable by at least one processor assembly to:
identify a missing or low quality slice of a frame of video; and
use a machine learning (ML) model to enhance at least the slice, wherein the frame is a first frame and the instructions are executable to:
use a slice from a frame prior to the first frame to reconstruct missing compressed domain information of the slice for use in presenting a second frame referencing the first frame.

14. The apparatus of claim 8, wherein the video comprises at least one computer game.

15. A method, comprising:
identifying at least a portion of a frame of video received over a computer network is missing or is low quality; and
reconstructing or enhancing at least the portion using a machine learning (ML) model over-trained on the video, wherein the frame is a first frame and the method comprises:
using the ML model to reconstruct missing compressed domain information of the slice for use in presenting a second frame referencing the first frame.

16. The method of claim 15, wherein the video comprises at least one computer game.

17. The method of claim 15, wherein the portion of the frame is identified as missing, and the method comprises reconstructing the portion using the ML model.

18. The method of claim 15, wherein the portion of the frame is identified as low quality, and the method comprises enhancing the portion using the ML model.

19. (canceled)

20. The method of claim 15, wherein the compressed domain information comprises motion vectors.
